(19) United States
(12) Patent Application Publication
(10) Pub. No.: US 2023/0157487 A1
(43) Pub. Date: May 25, 2023

(54) Dual Prong Skewer with Interlocking Shaft, Removable Tooled Handle and Integrated Storage Container

(71) Applicant: Justin Cowan, Oregon, WI (US)

(72) Inventor: Justin Cowan, Oregon, WI (US)

(21) Appl. No.: 18/059,427

(22) Filed: Nov. 29, 2022

(30) Foreign Application Priority Data
Jan. 21, 2022 (US) 63301607

(51) Int. Cl. A47J 43/28

(52) U.S. Cl. CPC A47J 43/283

(57) ABSTRACT

Dual Prong Skewer with Interlocking Shaft, Removable Tooled Handle and Integrated Storage Container is disclosed. This invention keeps hands at a safer distance to prevent burns. A person's hand should not come in contact with a skewer that has been exposed to the heat source. The dual prong skewer will provide ease of food turning. The integrated storage container will keep all the parts in one unit.

### BACKGROUND OF THE INVENTION

Problem Solved: Prevents burns to the skin from direct contact to hot skewer and indirect heat source. Cooking mitts or hot pads can catch fire or burn the skin through the material.

Prong type prevents skewer from spinning inside of the food.

Storage is always a problem with traditional skewers in the kitchen. Individual skewers spread out and cross over other items. Intermingled items can jam cabinet drawers.

Traditional skewers do not have built in precaution for the user's safety as this does. Kitchen organization as a kit will be a great improvement. A dual prong skewer formed onto the interlocking connection will provide confidence, stability and efficiency in food preparation.

This invention keeps hands at a safer distance to prevent burns. A person's hand should not come in contact with a skewer that has been exposed to the heat source. The dual prong skewer will provide ease of food turning. The integrated storage container will keep all the parts in one unit.

### SUMMARY OF THE INVENTION

A cooking skewer that accepts the attachment of an interlocking tooled handle, with integrated storage container.

The detachable handle will provide safer placement, turning and removal of a skewer from various cooking methods. The attachment of the storage tube provides self containing kitchen organization of all parts into one unit.

The consumer would have peace of mind provided by designed safety and functional ease of use. The product model would be chosen for the cooking application and skewer length. Consumers would have more cooking application options to suit their needs. The product would be a visually superior designed option.

The handle would be thermoformed from colored plastic and silicone with male threads. During this process the metal shaft and keyway barrel could be integrated or fused later with epoxy. The handle materials may be modified depending on customer demands, such as stainless steel, wood or bamboo.

The interlocking connection would consist of the following elements. The metal shaft and keyway barrel would be formed from a mold. The Barrel composed of Hollow Cylinder and Internal Keyway and Keyway Notch would mesh with the Single Tooth Spline Connector formed to Dual Prong Food Grade Metal Skewer. The food grade stainless steel skewer would be formed to a prong that would be fused to the single Tooth Splined Shaft. The (single spline tooth) keyed ends would insert-twist-pull to ‘lock’, and push-twist-pull to ‘unlock’ and separate. The skewers would be made in multiple lengths and forms to suit the cooking method.

The skewer storage tube would be thermoformed from clear plastic for product recognition with a keyed opening to fit the handle slot. The skewer storage tubes would be made in multiple lengths to house the specific skewer length model. To use the product, open the assembled unit by loosening the attached handle and storage container. Choose the desired number of skewers. To prepare the skewers for cooking, load with food. Attach the skewers individually to the handle shaft connector and ‘lock’ the skewer into the keyway notch. The (single spline tooth) keyed ends would insert-twist-pull to ‘lock’, and push-twist-pull to ‘unlock’ and separate. Apply the skewer to the cooking source release and remove the handle while cooking. To turn the food, reattach the handle and ‘lock’ then lift, turn. Release the locked keyway and remove the handle to finish cooking. To remove the food from a skewer attach the handle; use a kitchen tool to push the food off the skewer away from the handle. When finished using, return the cleaned skewers to the skewer storage tube. Turn the handle onto the storage tube.

### BRIEF DESCRIPTION OF DRAWINGS

The Version of the Invention Discussed Here Includes:
1. Handle
2. Metal Shaft with Barrel
3. Hollow Cylinder
4. Internal Keyway
5. Keyway Notch
6. Single Tooth Spline Connector formed to Dual Prong Food Grade Metal Skewer
7. Skewer Storage Tube
8. Storage Tube Keyed End
9. Handle Slotted End

### BRIEF DESCRIPTION OF THE SEVERAL VIEWS OF THE DRAWING

FIG. 1 illustrates a top view of skewer and spline tooth

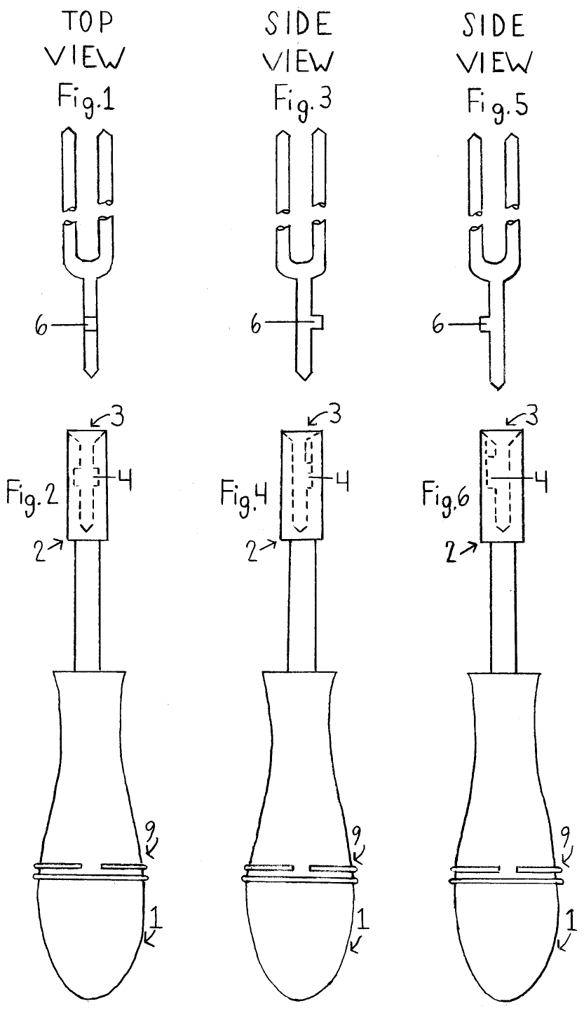

FIG. 2 illustrates a top view of handle, shaft, barrel and keyway.

FIG. 3 illustrates a side view of view of skewer and spline tooth.

FIG. 4 illustrates a side view of handle, shaft barrel and keyway.

FIG. 5 illustrates a opposite side view of view of skewer and spline tooth.

FIG. 6 illustrates a opposite side view of handle, shaft barrel and keyway.

FIG. 7 illustrates skewer storage tube, handle, shaft, barrel keyway and notch.

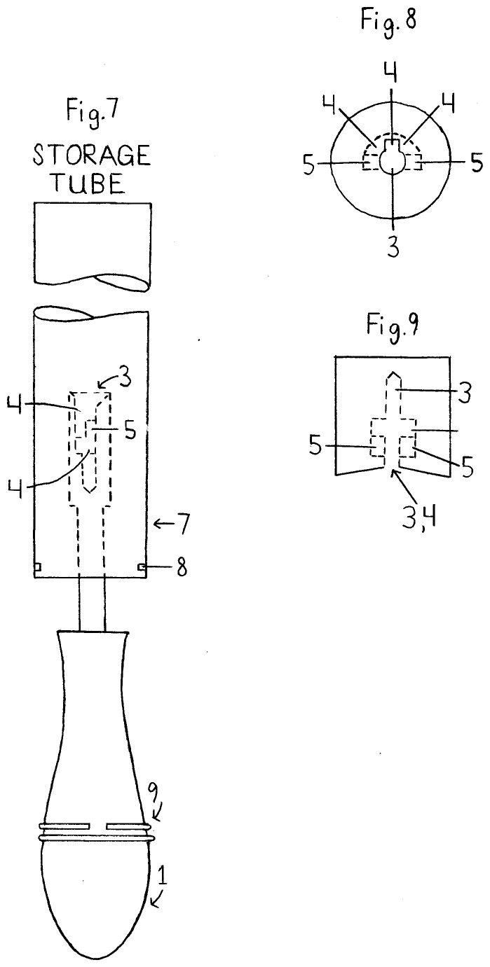

FIG. 8 illustrates end of barrel view of hollow cylinder and keyway.

FIG. 9 illustrates interior of the handle shaft barrel, keyway pattern on a horizontal plane.

### DETAILED DESCRIPTION OF THE DRAWING

FIG. 1 illustrates Skewer with Interlocking Shaft and (1) Removable Handle. The skewer shaft (6) will have a spline tooth near the end to mesh with the (2) Handle Shaft Barrel.

FIG. 2 the Handle Shaft Barrel (2) will have a hollow cylinder (3) and keyway (4) to accept the coupling of the (6) spline tooth of the skewer shaft. At the internal end of the (2) Handle Shaft Barrel (3) Hollow Cylinder and (4) Keyway, the keyway rotates to a (5) Notched keyway end; see: (FIG. 7; FIG. 9). The (3, 4) Hollow Cylinder, Keyway will allow the insertion and rotation of the (6) spline tooth and ‘lodge’ into the (5) Notch (FIG. 7, FIG. 9) when pulled. In this position the handle could not be removed. While (6) spline tooth is in the (5) notch the skewer shaft would be able to be turned, by rotating the (1) handle without detaching. Design modifications of the interlocking connection are protected as this is a utility patent for a 2 piece interlocking skewer.

FIG. 3-6 show opposing side views of the aforementioned description. The ability to rotate left or right and lodge the spline tooth in the notch, will allow for ease of use depending upon individual preferred dexterity.

FIG. 7 (5); FIG. 9 (5), the keyway notch extends toward the insertion end of the barrel. The spline tooth will lodge in the notch when pulled, allowing for rotation of the skewer blade in conjunction with the handle.

FIG. 8 illustrates the cylindrical shape of the handle shaft barrel. The hollow cylinder and keyway is shown as the insertion point for the skewer. Slight rotation of the handle may be necessary to align the skewer spline tooth with the barrel keyway.

FIG. 9 illustrates the cylindrical shape of the handle shaft barrel keyway on a horizontal plane. The end of the barrel has a taper to aid in alignment of when inserting the skewer. Slight rotation of the handle may be necessary to align the skewer spline tooth with the barrel keyway.

Relationship Between the Components: The (1) Handle would be formed or epoxy glued to the (2) Metal Shaft with Barrel composed of (3) Hollow Cylinder, (4) Internal Keyway and (5) keyway notch. The (2) Barrel composed of Hollow Cylinder and Internal Keyway and notch would mesh with the (6) Single Tooth Spline Connector formed to Dual Prong Food Grade Metal Skewer

For Storage: The (6) Single Tooth Spline Connector formed to Dual Prong Food Grade Metal Skewers would be inserted into the (7) Skewer Storage Tube with (8) Keyed End. The (1) Handle's (2) Metal Shaft with Barrel would be inserted into the (7) Skewer Storage Tube and (8) Keyed End, including (3) Single Tooth Spline Connector formed to Dual Prong Food Grade Metal Skewers. Then the (4) Skewer Storage Tube with (8) Keyed End would be turned onto the (1) Handle with (9) Slotted End.

How The Invention Works: Open the assembled unit by loosening the (1, 9) Slotted handle and (7,8) Keyed storage container. Choose the desired number of (6) skewers. Prepare the (6) skewers for cooking, load with food. Attach the (3) skewers individually to the (1, 2) handle shaft connector and ‘lock’ the skewer into the (4) keyway (5) notch. The (single spline tooth) keyed ends would insert-twist-pull to ‘lock’, and push-twist-pull to ‘unlock’ and separate. Apply the skewer to the cooking source. To turn the food, reattach the handle and ‘lock’ then lift, turn. Release the locked keyway and remove the handle to finish cooking. When finished using return the cleaned skewers to the (4) skewer storage tube. Turn the (1, 2) handle onto the (4) storage tube.

How to Make the Invention: The handle would be thermoformed formed from colored plastic and silicone with male threads. During this process the metal shaft and keyway barrel could be integrated or fused later with epoxy. The handle materials may be modified depending on customer demands, such as stainless steel, wood or bamboo. The metal shaft and keyway barrel would be formed from a mold.

The stainless steel skewer would be formed to a prong that would be fused to the single tooth splined shaft. The skewers would be made in multiple lengths to suit the cooking method. The skewer storage tube would be thermoformed from clear plastic for product recognition with a Keyed opening to fit the handle Slotted end. The skewer storage tubes would be made in multiple lengths to house the specific skewer length model.

### DETAILED DESCRIPTION OF THE INVENTION

As stated above, prevents burns to the skin from direct contact to hot skewer and indirect heat source. Cooking mitts or hot pads can catch fire or burn the skin through the material.

Prong type prevents skewer from spinning inside of the food. The skewers would be made to specific length to support cooking method form factor. The skewer shaft cooking end could be in multiple dimensions such as single shaft, flat blade, and 2 prong forks. The skewer cooking end would be available in multiple lengths to suit the cooking method and dimensions. Cooking methods could include indoor/outdoor grilling, smokers, deep fryers, fondue.

Storage is always a problem with traditional skewers in the kitchen. Individual skewers spread out and cross over other items. Intermingled items can jam cabinet drawers. The invention claimed here solves this problem.

The detachable handle will provide safer placement, turning and removal of a skewer from various cooking methods.

A dual prong prevents the skewer from spinning without turning the food.

The attachment of the storage tube provides self-containing kitchen organization of all parts into one unit.

The claimed invention differs from what currently exists. The need has not been met for a safer skewer. The heat is often too high to safely use a bare hand to place skewers. Skewer ends are often too hot and awkward to pick up safely to turn or remove from the heat source. This invention keeps hands at a safer distance to prevent burns.

Traditional skewers allow for messy clutter in drawers. This containment method will allow for using just the right number of skewers needed by grabbing one thing out of the drawer. The length of the skewers would relate to the model of the product. When finished and cleaned it can be neatly put away. The product model would have commensurate storage tube for containment of the skewers when not in use. The tube container attaches onto the handle, encompassing the handle shaft and barrel.

This invention is an improvement on what currently exists. The need has not been met for a safer skewer. The heat is often too high to safely use a bare hand to place skewers. Skewer ends are often too hot and awkward to pick up safely to turn or remove from the heat source. This invention keeps hands at a safer distance to prevent burns.

Traditional skewers bring your body to close to the heat source. Direct contact can burn skin potentially through hot pads or oven mitts. Food slips on skewers preventing ease of rotating on the heat source. Other skewers do not incorporate convenient storage solutions. This invention keeps hands at a safer distance to prevent burns. A person's hand should not come in contact with a skewer that has been exposed to the heat source. The dual prong skewer will provide ease of food turning. The integrated storage container will keep all the parts in one unit.

1. The skewer spline tooth would fit the design of the handle shaft barrel, once inserted with a turn of the handle and pull; the spline tooth shaft would interlock with the skewer barrel, to prevent the handle from being removed without first returning the shaft to the release position.

2. The handle would be formed in a manner to accept an attachable container and the detached skewers encompassing the handle shaft for organized storage.

3. The skewer cooking end would be available in multiple lengths to suit the cooking method and dimensions which may include indoor/outdoor grilling, smokers, deep fryers, fondue.
